(19) United States
(12) Patent Application Publication
(10) Pub. No.: US 2015/0120536 A1
(43) Pub. Date: Apr. 30, 2015

(54) ELECTRONIC PAYMENT AND AUTHENTICATION SYSTEM

(71) Applicant: Albert Talker, San Francisco, CA (US)

(72) Inventor: Albert Talker, San Francisco, CA (US)

(21) Appl. No.: 14/530,685

(22) Filed: Oct. 31, 2014

Related U.S. Application Data
(60) Provisional application No. 61/898,473, filed on Oct. 31, 2013.
(60) Provisional application No. 61/898,510, filed on Nov. 1, 2013.

(51) Int. Cl. G06Q 20/36; G06Q 20/38

(52) U.S. Cl. CPC G06Q 20/367; G06Q 20/38
USPC 705/39

(57) ABSTRACT

The invention relates to electronic currency transactions, facilitated by electronic equivalents of checks and credit/debit cards. The electronic equivalents are encrypted tokens, which are data units suitable for storage in and transfer between participants' data storage devices. The invention provides an electronic payment system having Check- and Card-Issuing Authorities that are coupled to a token-generating server. Electronic checks and credit/debit cards, backed by correspondent Check- and Card-Issuing Authorities, are generated and issued to subscribing customers as issuance tokens. A plurality of token-generating devices are used by participants to generate payment tokens authorized by the issuance tokens, and to perform electronic check and card transactions by exchanging tokens with other participants and participating Financial Institutions. The invention provides methods for authentication and verification of the token data, for maintaining the integrity of the system, and for detecting and preventing counterfeiting and tampering within the system.

### RELATED APPLICATIONS

This application claims benefit of priority of U.S. Provisional Patent Application No. 61/898,473 filed Oct. 31, 2013 and U.S. Provisional Patent Application No. 61/898,510 filed Nov. 1, 2013. The disclosures of both applications are incorporated herein by reference in their entirety.

### FIELD OF THE INVENTION

The invention relates to electronic checks, debit cards, and credit cards, to electronic wallets containing the same, and to electronic payment systems employing the same.

### BACKGROUND OF THE INVENTION

Electronic payment transactions have become increasingly important, and tremendous efforts are constantly placed into the development of suitable systems for carrying out such transactions. One such system is the so-called “electronic wallet” or “electronic purse”, which holds sums of money withdrawn from a bank, which can be used to pay for goods and services. The electronic wallet presents several problems, which, so far, have limited its use. It further presents a disadvantage that renders it unattractive for many persons, namely, it causes a loss of feeling of control over the money it contains and requires an online connection and a central server for verification and authentication.

With the ever-increasing popularity of personal mobile devices, e.g., cell phones, smartphones, personal digital assistants (PDAs), personal music players, laptops, etc., “mobility” has been the focus of many consumer products as well as services of wireless providers. For example, in the telecommunications industry, mobility is at the forefront, as consumers are no longer restricted by location with regard to communications and computing needs. Rather, today, as technology advances, more and more consumers use portable devices in day-to-day activities, planning and entertainment.

Electronic checks and cards have many applications, ranging from the use of electronic wallets carried on the owner in his portable device, in lieu of credit cards, in daily transactions and including payments for goods and services purchased over the Internet. The problems associated with payments over the Internet are well known, and many solutions have been suggested. The problem is a complicated one, because the use of cards and checks over the Internet is difficult to secure against fraud and theft.

Ever since the adoption of credit and debit cards, the world has been moving toward becoming a cashless society. Consumers are relying predominantly on non-cash based payments: credit cards, debit cards, automated check processing, pre-paid cards, etc. As society moves towards virtual payments, challenges and opportunities spring up.

As the wallet in consumers' pockets moves from the physical to the “virtual”, security surrounding the virtual wallet becomes critical. The payment-processing industry faces three main challenges based on the current market trends: user identification, fraud, and interchange fees. User identification has been a perennial problem for the industry. For example, how does a store clerk know that the person presenting a card is the actual owner of the account, or is authorized to use the account? This problem is particularly severe in the e-commerce world, where there is typically no in-person interaction between buyer and seller.

Fraud is one of the biggest threats to the payment processing industry. There are many forms of fraud that plague the payment industry, such as hackers and “phishers” stealing identities of consumers; the theft of card information; the manufacture of phony cards using stolen information, fictitious merchants; dishonest merchants overcharging customers; and credit card number generators targeting consumers.

Conventional paper check payments also suffer from a number of disadvantages. The reliance on mail and courier services to deliver checks inhibits the usage of checks for same-day or inter-day payments for all but a small percentage of check payments. In addition, paper checks are easily forged and altered, consume valuable resources including energy, paper and inks, and incur the overhead and labor costs associated with physical transportation and processing.

Alternatives to paper checking also suffer from a number of disadvantages. By way of example, traditional electronic payments require the Payee to share banking information with the Payor, which requires a trusted relationship. Additionally, ACH payments take days to process and weeks to set up initially. ACH payments are commonly followed by remittance information being printed and mailed to the Payee. Another alternative is the use of wire transfers, which can be fast but are costly to use.

It is expected that credit and debit cards will be the dominant on-line point of sale (POS) payment choice for at least the next five years. While new Internet payment mechanisms have been rapidly emerging, consumers and merchants have been happily conducting a growing volume of commerce using basic credit card functionality, and they continue to use paper checks for major purchases. None of the emerging alternatives to date have gotten more than a toehold in the market place and momentum continues to build in favor of credit and debit cards.

Debit and credit card transactions are currently processed using the Electronic Funds Transfer (EFT) network. The debit message comprising the transaction is carried over the EFT network from the point of origination (e.g., a Point of Sale (POS) location, an ATM machine, or an Internet merchant) to the financial institution that issued the card, or its representative.

Among the systems suggested for overcoming credit and debit card fraud while transitioning payment methods to electronic wallets, there are a few that can be mentioned in particular. For instance, a concept called First Virtual™ first asks a potential customer to fill out an application form providing standard personal information. First Virtual™ would then send a personal identification number (PIN) with an 800 number over the Internet to the customer via email. The customer then uses the 800 number to give the customer's credit card information over the phone to First Virtual™, to establish or open a basic electronic charge account.

Another concept called Cybercash™ requires customers or buyers on the Internet to first open a special Cybercash™ account that contains money designated for spending on the Internet. A consumer issues instructions to purchase goods or services on the Internet and money for these items are transferred from the consumer's Cybercash™ bank account to that of the merchant's. Transactions are anonymous unless the seller specifically asks for the identity of the buyer.

Mobile device penetration is one reason for the increased demand for electronic equivalents of credit card, debit card, and check payment systems. In the developing world, for example, a majority of the population can access mobile handsets. In fact, such mobile communication devices bridge the financial divide for the so-called “unbanked population” (those without checking accounts) by allowing them to use mobile devices to execute monetary transactions. For example, a mobile phone subscriber can prepay for services by depositing cash with an MNO (Mobile Network Operator); and use such credit, via the mobile device, for payment of purchased goods or services.

There is currently no electronic check or credit/debit card that can be used in a simple manner by the general public as well as by Internet surfers. For this reason, e-commerce is still relatively limited both in physical transactions, such as in shops and in service-providing establishments, and over the Internet.

While the use of credit cards has supported the growth of electronic commerce, credit card transactions pose certain risks to merchants. Since an Internet transaction is conducted remotely, the transaction is viewed as a “card not present” or a “mail order/telephone order” (“MOTO”) transaction. Unlike a face-to-face transaction where an imprint of a user's physical signature is obtained, if a cardholder disputes a charge in a MOTO transaction, the merchant, not the buyer, is liable for the charge. In addition, even though electronic signatures are legally recognized, the adoption of such signatures is in its infancy, and there is no widespread or uniform technology in use to reasonably support authentication of electronic signatures.

Another difficulty with credit cards is that they are not acceptable for all transactions. For example, most brokerage firms do not accept credit card payments, thereby requiring the consumer to either send a paper check or utilize a wire transfer to convey money to the brokerage firm. This process can delay transactions the consumer wishes to perform, and result in a loss of consumer goodwill.

Another difficulty with checks and credit cards is that some individuals do not possess checks or credit cards at all, and other consumers only possess credit cards that are not widely accepted. If merchants do not accept checks, and only accept some credit cards, and have no efficient way other than cash to accept money from consumers, the merchant may miss out on a large number of consumers that otherwise would be part of the merchant's target market.

A further difficulty with credit cards is that the transactional costs associated with accepting credit card payments are often significant. The transactional costs, which are absorbed by the merchant, can have a substantial affect on the merchant's bottom line. Credit card fees can be up to 5% (or even higher for certain product groups) of the transaction total. Additionally, there is often a time delay between the time a credit card payment is accepted by the merchant and the time the credit card company transfers money to the merchant's bank account. This time delay reduces the amount of interest income the merchant can earn, and reduces the merchant's cash flow. The transactional costs, along with the other problems discussed above, can make accepting credit card payments very expensive for merchants.

There is a great need for electronic check and credit/debit card systems that overcome the aforementioned drawbacks, and which permit commerce and e-commerce to proceed freely, in a manner as similar as possible to live commerce.

It is a purpose of this invention to provide valid monetary units in the form of electronic credit and debit card information that can be securely transferred in real time from one user to another. Other purposes and advantages of this invention will appear as the description proceeds.

### SUMMARY OF THE INVENTION

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description presented further below.

The present invention relates to systems and/or methods that facilitate securing a digital payment between electronic devices, preferably including at least one mobile device. The system and methods of the invention, collectively, are referred to herein as “The System”. Electronic payment checks or cards are provided; these are stored on a mobile electronic wallet or on a mobile communication device, wherein they can be utilized for digital wireless payments with a payment terminal. In particular, the electronic checks or cards can be linked to an account related to, for instance, a bank, a credit card company, a financial institution, etc. The electronic payment data can be wirelessly transmitted in a secure manner to a payment terminal. Once a portion of the electronic payment card data is received by the payment terminal, such portion can be verified and/or authenticated by communicating with the virtual card issuing entity (e.g., a bank, a credit card company, a financial institution, etc.). In general, a mobile device with embedded electronic payment card data according to the present invention can enhance wireless payments in a secure and protected manner. The claimed subject matter provides better user identification, reduces fraud rates, and verifies authenticity of payment terminals and mobile devices.

To achieve the foregoing, and other objects of the invention, The System of the present invention employs a preferred embodiment in the form of an electronic credit/debit system having (1) at least one check- or card-issuing Central Issuing Authority (CIA) coupled to electronic check and credit/debit card generator servers for generating and issuing to participants electronic checks and credit/debit cards that are issued in coordination with correspondent banks that accept and distribute the electronic checks and cards; (2) a plurality of transaction devices that are used by participants for storing electronic checks and cards and for performing check and credit/debit card transactions with the on-line systems of the participating banks or for exchanging electronic check and card information with other like transaction devices in off-line transactions; (3) a data communications system for providing communications services to all components of the system; and (4) a security arrangement and verification system for maintaining the integrity of the system, and for detecting counterfeiting and tampering within the system. The CIA issues electronic credit/debit cards to participants.

The CIA is not involved in the transactions carried out with the checks or cards that it issues, but is responsible for the maintenance of The System. The CIA may be a national government or an organization within it, such as a treasury or central bank, or another trusted financial organization. As with the treasury of a country, the basic condition for a currency to be of value is the solvency of the CIA or of the organization it represents. There is no limitation on the number of CIAs that may issue electronic checks, and just as with countries, exchange rates can be established between different currencies issued by different CIAs. A CIA may be electronically connected with multiple financial organizations (banks), where issued electronic cards and checks can be delivered to be distributed to the participants of the system via the financial organizations.

In a preferred embodiment of the present invention, the system includes a CIA for generating and issuing to subscribing participants' electronic checks and debit and credit cards for the respective accounts held in correspondent banks that accept and distribute the electronic checks and cards. The system include a plurality of devices that are used by participants for storing electronic checks and cards, and for performing transactions with on-line systems of the participating banks or for exchanging electronic checks with other like transaction devices in off-line transactions. The electronic checks and cards are issued and signed by the CIA. The system includes data communications systems for providing communications services to all components of the system; and security arrangement and verification systems for maintaining the integrity of the system, and for detecting counterfeiting and tampering within the system.

As said, the electronic checks and cards of the invention can be used in any way, for electronic commerce, whether by means of an electronic wallet carried by the owner, or in remote e-commerce carried out over communication lines, such as cellular telephone systems or any other line of communication over which e-commerce can be effected, the most important example of which is the Internet.

Throughout this specification, when reference is made to the Internet as the e-commerce system, the term refers as well to other communication methods or systems over which e-commerce can be effected, and the description to follow applies mutatis mutandis to any such communication method and system. The Internet is used here for the sake of illustration, it being understood that the invention is not limited to it, or to any other particular system. Furthermore, when reference is made to a network, it may also refer to mixed networks, e.g., where two different networks cooperate in the communication system, such as may be a cooperation of the Internet with a cellular phone system, via an appropriate interface as will be easily appreciated by the skilled person.

All the above and other characteristics and advantages of the invention will be better understood through the following illustrative and non-limitative description of specific embodiments thereof.

### BRIEF DESCRIPTION OF THE DRAWINGS

FIG. 1 schematically illustrates an overview of the system's components, according to a preferred embodiment, by which a payer pays a payee using a CIA-issued electronic credit/debit card.

FIG. 2 is a schematic representation of electronic check issuance and payment process using electronic checks, according to a preferred embodiment of the invention.

FIG. 3 schematically illustrates a payment process using an electronic check to purchase a ticket, and storing the purchased ticket in a payer device.

FIG. 4 schematically illustrates a payment process using an electronic check to purchase a ticket.

FIG. 5 schematically illustrates a payment process using the issued electronic checks, according to a preferred embodiment of the invention.

FIG. 6 illustrates the hardware components of a portable device which contains electronic checks and cards as part of an electronic wallet.

FIG. 7 is a schematic representation of an electronic credit/debit card issuance and payment process using electronic credit/debit cards, according to a preferred embodiment of the invention.

FIG. 8 schematically illustrates a payment process using an electronic credit/debit card to purchase a ticket, and storing the purchased ticket in a payer device.

FIG. 9 schematically illustrates a payment process using an electronic credit/debit card to purchase a ticket.

FIG. 10 is a schematic representation of an electronic payment process using an electronic debit/credit card via a payee's device.

### DETAILED DESCRIPTION OF PREFERRED EMBODIMENTS

In the context of the present disclosure, the terms “issuance check” and “payment check” and “electronic check”, as well as “internet check”, are used interchangeably; the terms “issuance card” and “payment card” and “electronic card”, as well as “internet card”, are used interchangeably; the terms “Payer” and “Participant” are used interchangeably to designate a participant payer that pays with an electronic check or electronic credit/debit card; and the terms “Payee” and “Retailer/Merchant” are used interchangeably to designate a participant payee that gets paid with an electronic check or electronic credit/debit card. In the context of the present disclosure, the terms “Credit Card” and “Debit Card”, are used interchangeably, as the invention operates in the same manner for both types of card.

The invention provides, in general, a system for making monetary payments between participant payers and payees. The system comprises at least one Central Issuing Authority (CIA), at least one electronic server for generating and issuing electronic checks, debit cards and credit cards, in the form of Issuance Tokens, to participant payers; and a plurality of portable transaction devices for use by participant payers. Each device has a unique ID and each device is adapted for the storage of Issuance Tokens, the generation of Payment Tokens, communicating with participant payees, and performing check and credit/debit card transactions with participant payees. The CIA electronic server generates Issuance Tokens in coordination with correspondent banks that associate each Issuance Token with an account of an individual participant payer. Each Issuance Token is signed with a CIA private key, identified by a specific serial number which is a data element of the Issuance Token. Each Payment Token comprises a public key identifying the monetary value represented by the Payment Token, the Issuance Token from which the Payment Token is derived, the individual participant payer whose account is associated with the Issuance Token, and the unique ID of the individual participant payee's transaction device.

The invention also provides a portable device for the generation, storage, and transmission of Payment Tokens. The device includes a display, a means for operator input of commands and information, computer memory, a secure digital data storage area in the computer memory, a communications port, an application program (Software) in the computer memory, and a processor configured to execute the application program. Execution of the application program enables an operator of the device to enter into the computer memory data identifying a checking or credit card account, create a request for a Check Issuance Token or a Card Issuance Token, transmit the request to a Central Issuing Authority, and receive a Check Issuance Token or a Card Issuance Token. The means for operator input may be a touch screen or a physical keyboard.

Execution of the application program further enables the operator of the device to receive a digital certificate. Execution of the application program also enables the operator of the device to enter into the computer memory data identifying a payee, enter into the computer memory data specifying an amount to be paid to the payee, create a Check or Card Payment Token derived from the Check or Card Issuance Token, sign the Check or Card Payment Token with the digital certificate, and transmit the Check or Card Payment Token to the payee or to an account of the payee. Execution of the application program may also enable the operator of the device to receive and authenticate a Payee Confirmation.

The application program may cause an image of a check, made out to the payee for the amount to be paid to the payee, to be displayed. The application program may cause the image of a credit card charge slip, identifying the payee and showing a charge for the amount to be paid to the payee, to be displayed.

The system of the invention will now be described in detail, and will be referred to herein as “The System”, for the sake of brevity. It resembles in many features the system of a collection of banks, in which there is a Central Issuing Authority (CIA) that issues electronic checks and cards, and possibly other forms of money accepted in the relevant markets as payment (bills, coins, cash tokens, payment coupons or money orders) to individuals/payers.

A currency issuing authority, such as a national treasury, is not involved in the transactions carried out with the currency and credits that it issues, but is responsible for maintenance of the system, and in some cases it may also control the money supply and provide liquidity to the banking system. In the system of the present invention, a CIA functions in a similar manner, but with improvements and differences that will be explained in detail below. The CIA may be a country (national government) or an organization within it, a bank, a collection of banks, a financial organization, or any other organization which maintains and uses payment systems. There is no limitation on the number of CIAs that may issue electronic cards and checks. A CIA may be electronically connected with multiple financial organizations, where issued cards and checks could be delivered, to be distributed to the participants of the system via the financial organizations.

The electronic cards exchanged by the different participants of the System may be electronic representations of plastic debit or credit cards, and electronic checks may be electronic representations of paper checks. The electronic card and check representations are fungible, universally accepted, and undeniably redeemable from the issuing banks, i.e., they have most of the characteristics of card, cash, or check transactions. To preserve the integrity of the electronic cards system, each exchange of electronic card includes, along with other information, data identifying the monetary unit of the currency (e.g., dollars, euros, yen, etc.), the amount (number of units) of the currency being transacted, the Payee name or other identifying information, and a plurality of digital signatures which are used to authenticate the card or check.

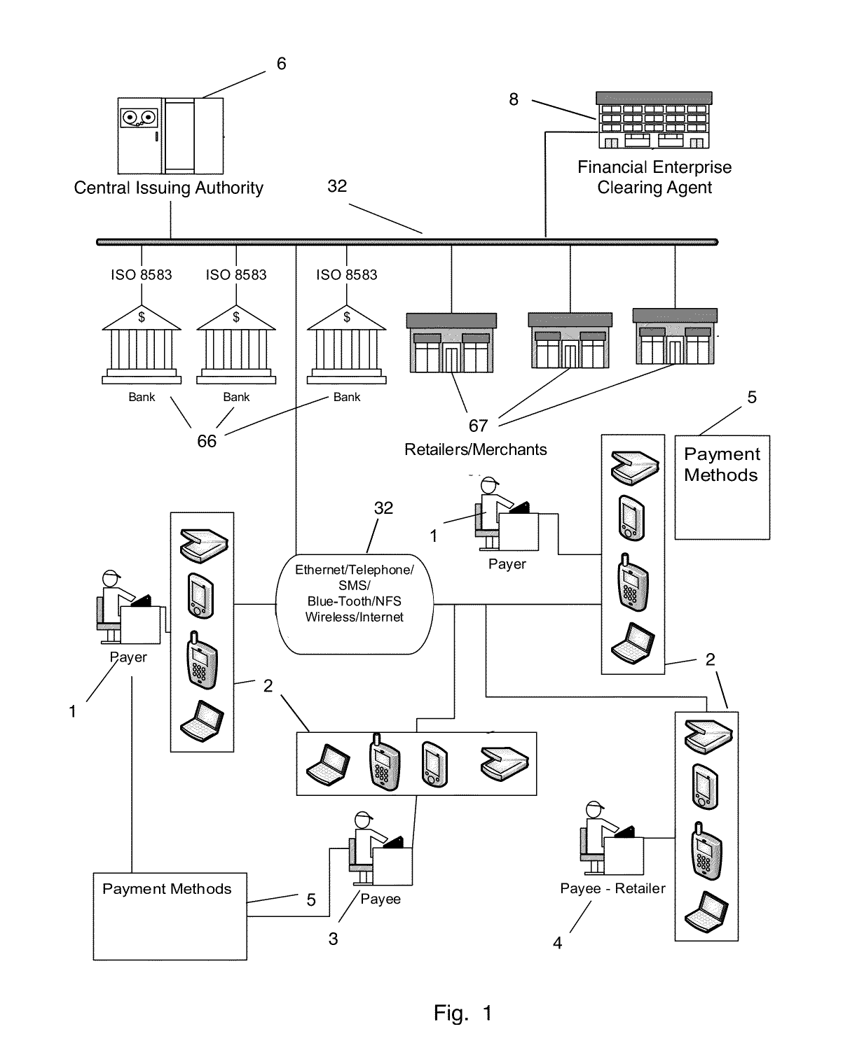

FIG. 1 schematically illustrates an overview of this system and its components, according to a preferred embodiment of the invention. The System comprises a CIA 6, at least one financial enterprise clearing agent 8, and a plurality of Banks 66 and Retailers and Merchants 67, in electronic communication over a communication network 32. The network 32 may comprise one or more wired or wireless communication systems and protocols, including but not limited to telephone and Ethernet wired systems, the Internet, and secure wireless protocols such as NFC (near field communications), Wi-Fi, Wi-Max, and the like. An electronic payment according to this invention is depicted as one of the payments options available to Payers 1 as part of a system-wide electronic wallet payment, by which any Payer 1 can pay an individual Payee 3 or a Payee-Retailer 4 using the one of the available Electronic Payment methods 5 (i.e., payment via electronic check, debit card, or credit card.) Payers and Payees may interact with one another and with The System via a variety of devices 2, including but not limited to desktop computers, laptops, tablets, and smartphones.

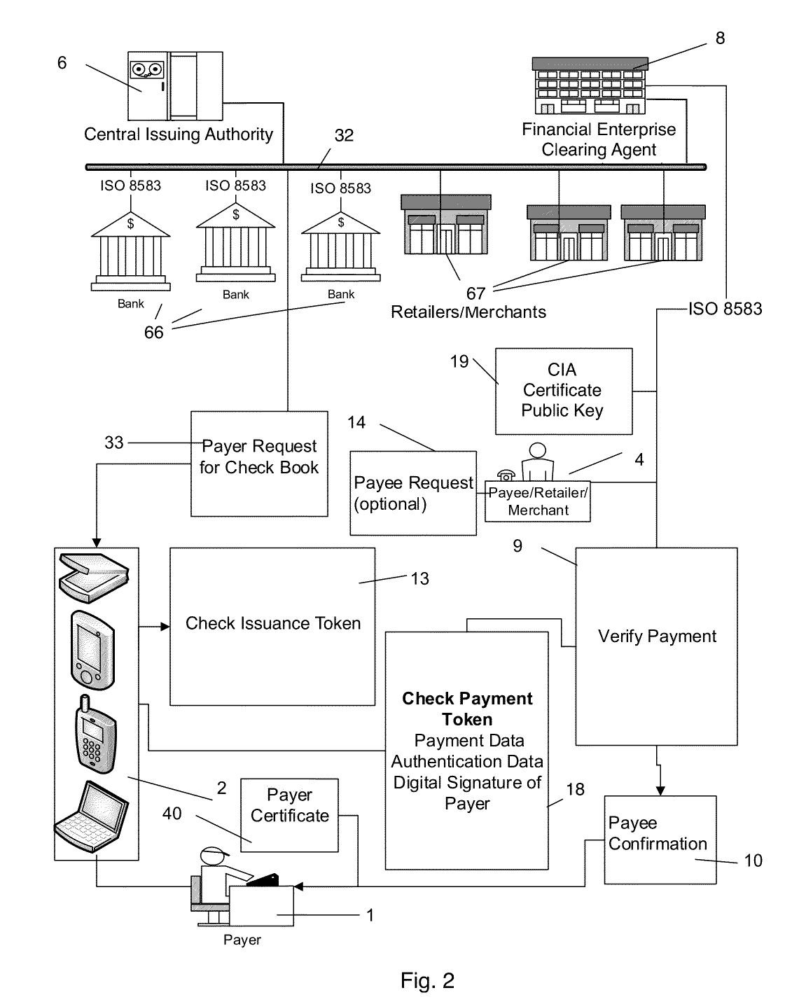

FIG. 2 shows an exemplary embodiment of the invention, illustrating electronic check issuance according to The System. According to this embodiment, a Payer-participant 1 submits a request 33 for blank checks from the CIA 6, either directly or through a Financial Organization/Clearing Agent 8 or a Bank 66 acting as intermediaries. The Payer 1 may submit the request using any of several devices 2; requests can also be submitted in writing on paper forms, or online via an Internet application. The request 33 includes at least a device ID that is unique to one of the Payer's devices 2, the Account Number which the Payer wishes to have associated with the checks or cards, and the corresponding Bank ID (routing or ABA number.) When a valid certificate does not exist in the device 2, a Certificate request, or CSR, will be included in the request 33, based on a specific private key assigned to the Payer and/or to the device 2.

When the CIA gets a confirmation from the participants' banks 66 for a request for electronic checks, the CIA issues an electronic Check Issuance Token 13, which consists of electronic information that, according to the invention, comprises at least the following:
1. CIA Server Name: Identifies a check issuance server or root bank;
2. Issuance Date: The date of issuance of Check Issuance Token 13;
3. Expiry Date: Limits the time period of the validity Check Issuance Token 13.
4. Token Serial Number: Uniquely identifies each Check Issuance Token 13.
5. Device ID: The Payer device 2 ID to which the Check Issuance Token was issued; and
6. Cert/key#: The Root Authorization Certificate serial number used to sign the Check Issuance Token 13.

In addition to the Check Issuance Tokens the CIA issues a device/user Certificate when the device 2 does not have such a certificate. The certificate is issued to the Payer and is associated with the ID of the device 2 which is used to store the Check Issuance Token 13.

The Check Issuance Token 13 is signed with one of the CIA 6 or Bank 66 private keys, the specific serial number of which is a data element of the electronic information of the Check Issuance Token. These serial numbers serve to identify the corresponding public certificate. The corresponding CIA or Bank public keys (referred to herein as “CIA certificates”) are published, are distributed to all participants of the system, and are available to any participant. The CIA publishes all the certificates used for Check Issuance, and any new root certificates it generates and distributes to the participants.

Each Check Issuance Token 13 is digitally signed by the bank or the CIA using a Root Authorization Certificate number, and has a unique token serial number. The CIA server keeps track of the serial numbers of the Check Issuance Tokens 13 within the system.

When the Check Issuance Token 13 is received by the Payer, it is stored in the payers' device 2 as a single data unit. This data unit can be delivered to the Payer in any suitable form, e.g., in magnetic form, such as on a hard drive or diskette, in optical form, e.g., on a CD-ROM, or in electronic form in a solid state memory device, e.g. a USB drive or SD card. The Token data unit can also be transferred to the user via electronic mail, TCP/IP, or other communication method. Thus, there is no limitation whatsoever to the channel through which the electronic checks can be provided to the user.

According to a preferred embodiment of the invention, the payer's device 2 will be installed with software, which will be termed hereinafter “Software”, the purpose of which will become apparent from the description to follow. The Software can be pre-installed on Device 2, or it can be provided to the Payer 1 by any means known for software distribution; a preferred means is by downloading it over the Internet. The Software installed on the payer's device 2 is used, according to this embodiment of the invention, to allow access to a remote CIA server and to gain access to a (preferably secure) storage area of the payer's device 2. The Software assists the process in facilitating access to the CIA server by executing appropriate communication protocols, and preferably provides security features that prevent fraudulent activities. The Software can further function as the program that actually cooperates in the transfer of the Check Issuance Tokens 13 and Check Payment Tokens 18 from the payer 1 to the Payee/Retailer/Merchant 4, the provider of services or goods. The software may also display, on the participants' device 2, a graphical representation of the Check Issuance Token and some of its data elements, e.g., an image of what would be the equivalent paper check. This optional feature serves to give new users a sense of familiarity, and a greater level of comfort, with transactions carried out using the System.

FIG. 2 also schematically illustrates a payment process, by which a Payer 1 pays a Payee/Retailer/Merchant 4 using an issued Check Issuance Token 13. Payer 1 interacts with a Payee 4, using one of the Payer Devices 2, via the Internet or using other wireless or wired communication methods and protocols (e.g., 3G, 4G, Bluetooth, NFC, or SMS texting). When an electronic check transaction has been agreed upon, and the time comes to make actual payment, the Payee 4 can optionally “effect payment”, by issuing a Payee Payment Request 14. Payments Request 14 includes the Payee's device ID and/or the Payee's ID and optionally the payment amount. Upon receipt of the payment Request 14 to pay a given sum to the Payee 4, or when the Payer 1 initiates payment by providing the Payee data, Payer 1 enters into his device the payment amount and the payee name (“pay to the order of”) and other information required by The System to effect a payment. Then the Payer Device 2 generates and sends to the Payee 4 a Check Payment Token 18. The Payee's device ID, the check issuance token 13, and other payee information are signed into the Check Payment token 18. It should be noted that the Check Payment token 18 includes the data of the check issuance token 13, which is otherwise equivalent to a blank check.

It is a notable feature of the present invention that the Payer 1, after being provided with Check Issuance Tokens 13, can generate and transfer valid and redeemable Check Payment Tokens 18 to one or more Payees, without involvement of the CIA 6, Banks 66, or Clearing Agent 8.

Communication between the payee′ and payers' devices is preferably done using the incorporated Software. The Software preferably manages the transmission of the Check Payment Token 18 and the certificate exchanges, and signs into the Check Payment Token 18 the Payee's identity, device ID and other Payee information using a private key associated with the Payer's public certificate 40. The Software installed in the Payee's devices receives the data packets that constitute the Check Payment Token 18, and examines the data packets and verifies (9) their authenticity. The software uses the published CIA certificate 19 and the Payer's Certificate 40 to verify the authenticity and validity of the data of Check Payment Token 18. The Payee optionally can further verify the Check Payment Token 18 via the Internet, using ISO 8583 financial messaging as depicted in FIG. 1. The CIA 6 can provide authenticity information to the payee based on the serial number and the payer's device ID, which are stored as data elements in the Check Issuance Token 13 and in the Check Payment token 18. However, in practice, it is expected that the published CIA root certificate 19 and the Payer's Certificate 40 are sufficient to validate the payment. When the Payee deposits the Check Payment Token into his bank account or with a Financial Enterprise/Clearing Agent 8, the Check Payment Token 18 is removed from circulation, and any attempts at further deposits of the same Token will indicate a fraud, and will not be processed. The Payee may optionally query the Financial Enterprise/Clearing Agent 8 regarding the validity of the Check Payment Token, using the ISO 8583 financial message protocol, in which case the check issuing system will either authorize or decline the transaction, and generate a response message accordingly. Upon deposit of the Check Payment Token, the Payer's account that is associated with the Check Payment Token is debited, and the Payee's account is credited, by the amount specified by the Check Payment Token, thereby completing the transaction.

Alternatively, the Software may be used to transfer the Check Payment Tokens directly to the Financial Enterprise/Clearing Agent 8 or to the Payee's bank 66 for later deposit, at a time elected or agreed upon by the Payee and/or the Payer. Variations on the described procedures for transferring and exchanging Check Payment Tokens can readily be devised by a skilled person.

According to a preferred embodiment of the invention, in order to facilitate record keeping, the Software writes and stores suitable information on the transactions in a protected data area of the Payer's device 2, and similar information may be written to a device of the Payee.

In the course of issuing Check Issuance Token 13, and/or Check Payment Token 18, or in the course of facilitating any transaction between the Payer 1 and the Payee 4, the invention provides for a commission for the service, which may be charged to the Payer 1, the Payee 4, and/or the Retailers/Merchants 67. The imposition of a commission will be regulated by predetermined rules between and among the CIA 6, the participating Banks 66 and Retailers/Merchants 67, and the Payers 1, Payees 9, and other participants in the System.

With each completed payment transaction, the Payee's Software sends a Payee Confirmation 10 to the Payer. The Payee Confirmation 10 comprises at least the following data elements:
1. Payment Amount;
2. Payment ID (Payment Token number or check number);
3. Payment Date; and
4. Payee ID or Payee Device ID.

A confirmation number and a Payee's Certificate/Key, to be used for Payment Confirmation, may be included. When the Payee confirmation 10 is received by the Payer's Device 2, the Software on the device removes the Check Payment Token 18 from its storage area on Device 2, and/or marks it as used. The Software can then record additional information concerning the transaction, such as the identity and Device ID of the Payee to which the Payment Token has been transferred, the date and time of the transaction, etc., as explained above, for the purpose of record keeping.

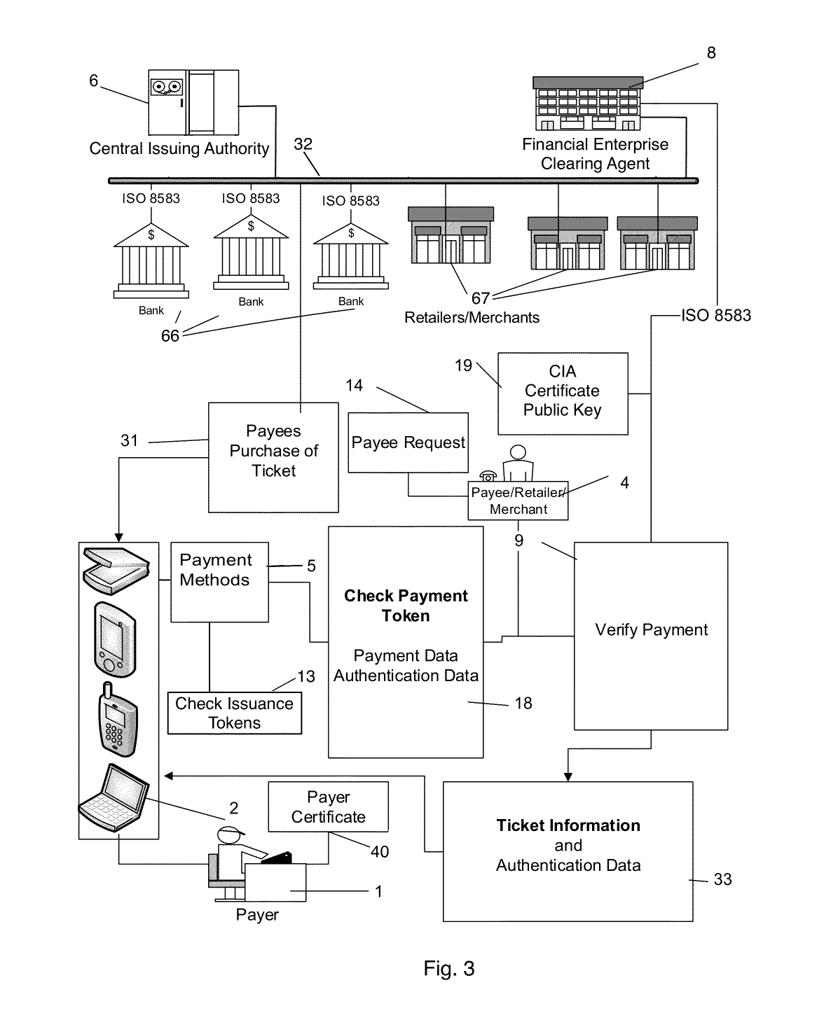

FIG. 3 schematically illustrates a payment process using the same issued electronic check, according to a preferred embodiment of the invention, by which a Payer 1 pays the Payee 4 using Check Payment Token 18. Payer 1 interacts with a Payee 4, using Payer's Device 2, as described above. In this embodiment the Payee 1 purchases (31) a Ticket from the Payee 4. When a transaction has been decided upon, payment is effected as described above via the Software of the invention. In this embodiment, payment confirmation is in the form of an electronic ticket 33 purchased by the payee. The electronic ticket 33 comprises at least the following data elements:
1. Payment amount,
2. Payment and issuance dates,
3. Payers Device ID and Payer's ID,
4. Check Payment Token number or check number.
5. Ticket Data (ID number, event/flight, date, time, etc.), and
6. Digital signature of ticket issuer.

As above, a confirmation number and a Payee's Certificate/Key, to be used for Payment Confirmation, may be included. The ticket data is then stored in the payer's device 2 and can be presented graphically or delivered electronically in order to redeem the ticket, or to any person or entity requesting to validate or view the ticket.

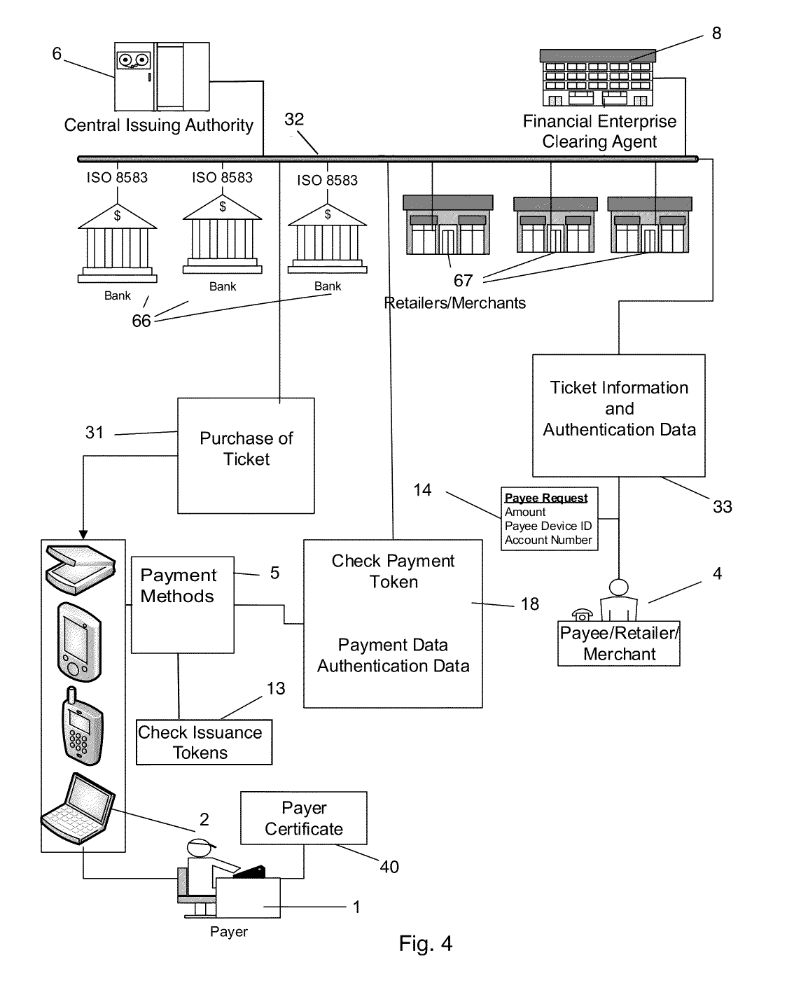

FIG. 4 illustrates a payment process for purchase of a ticket, analogous to that shown in FIG. 3, but wherein the ticket is not delivered to Payer's device 2. In this embodiment, the ticket is not delivered by the System or Software of the invention, but is delivered by prior art means, such as mail or courier delivery of a paper copy, or by electronic transmission of a printable email attachment or downloadable file.

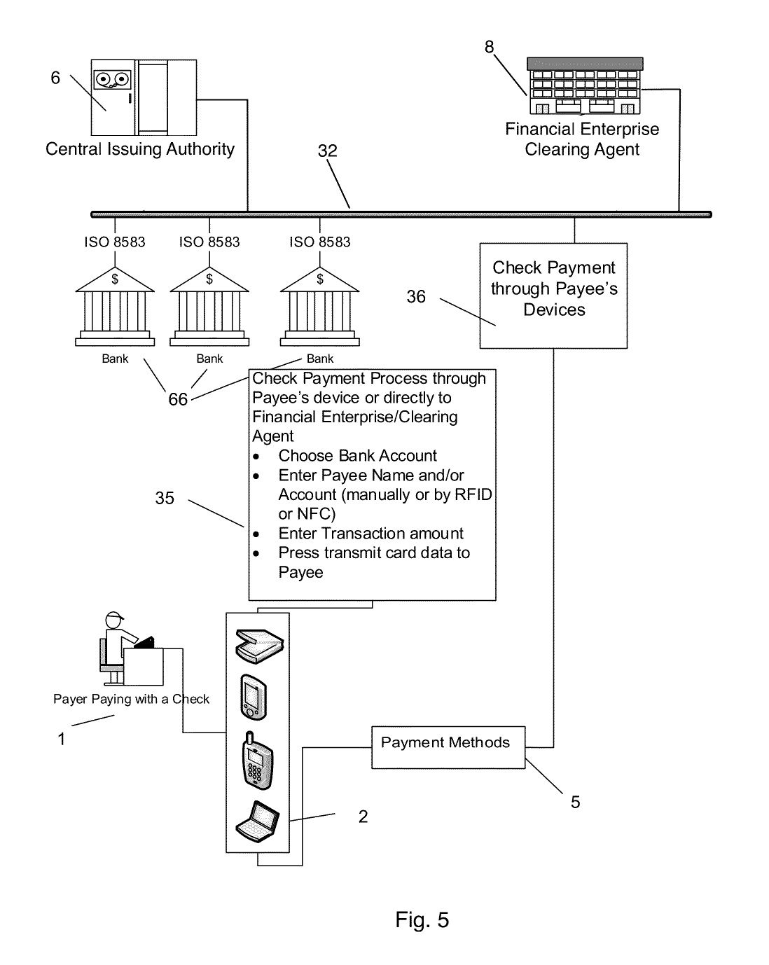

FIG. 5 schematically illustrates a payment process 35 using issued electronic Check Issuance Tokens, according to an alternative embodiment of the invention. The Payer 1 effectuates a payment via device 2 by doing the following:
1. Selecting payment by check from the available Payment Methods 5;
2. Choosing a Bank and an Account from a drop down menu of those Payer checking accounts for which check issuance tokens are present on the device;
3. Entering a Payee identification (name, ID number, or selection from a list);
4. Entering a Transaction amount; and
5. Issuing a command to transmit check data to the Payee or to the Financial Enterprise/Clearing Agent 8.

Optionally, the Payer may enter transaction identifying information, such as the Payee's invoice number. In alternative embodiments, Payee and transaction identification information may be automatically entered by the Software in response to a Payee Request. The software will transmit an electronically signed Check Payment Token 18 to the requesting payee's device 36. The Payee software then verifies the Check Payment Token data with the Payer and CIA public certificates and the device ID of the payee. Optionally an ISO 8583 message could be sent to the issuing bank to further verify the payment token. The Payee then deposits the Check Payment Token into the Payee's bank account, at which point funds are debited from the Payer's account and credited to the Payee's account, completing the transaction.

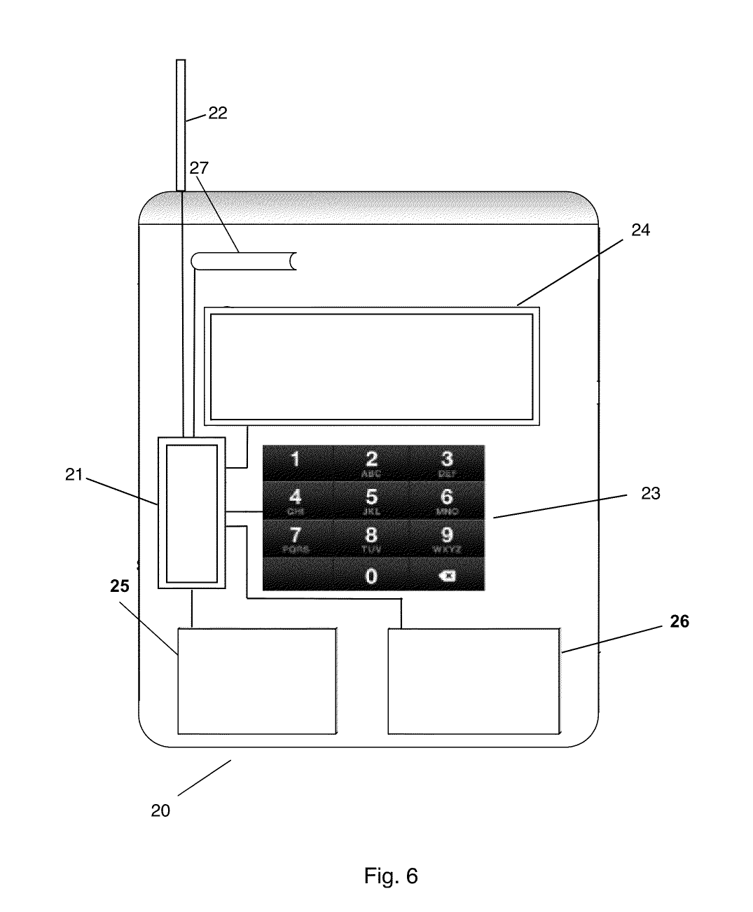

FIG. 6 schematically and graphically illustrates the hardware layout of one embodiment of payees' and payers' devices. In accordance with this disclosed embodiment, an electronic wallet device 20 may include a graphical user interface (GUI) with one or more graphical elements that may be moved or pressed by a user to confirm or decline a payment transaction using a keyboard 23 and/or any graphical buttons on the display screen 24. For example, in one embodiment, the GUI may instruct the user to press one of the keyboard buttons 23 in order to confirm the payment transaction, or another keyboard button to decline the transaction. In accordance with another embodiment, the GUI may display an image of a check, credit card or debit card, or a debit/credit card payment slip. The image may be animated so as to indicate that the payment is being moved to the payee's device, to confirm the payment transaction. The keyboard 23 may be a physical keyboard as shown, or it may be a virtual keyboard displayed on screen 24.

The electronic device 20 may transmit the check or card token, and receive a confirmation message, using wireless communication antenna 22. The communication itself may take the form of a cell-phone (e.g. TDMA, FDMA, CDMA or OFDM) transmission, a Wi-Fi transmission to a router, or other means of wireless connectivity, with appropriate circuitry as is known in the art. A payment sequence may also be conducted using RFID apparatus 27. Wallet data storage element 25 is a secure storage area, used to store the user's check and card Issuance Tokens, account balances, transaction records, and the user's private certificate keys. The certificate data storage element 26 is used to store publicly available certificates that were issued by the CIA and other participating members, including Banks, Retailers and Clearing Agents. The data storage elements 25 and 26 may be any devices known in the field for storage of data elements in computing device, although solid state memory is preferred. Operation of all of the elements shown, and the execution of the Software of the invention, is managed by processor 21.

All of the elements of device 20 can, in certain embodiments, be built or programmed into a smart phone, tablet, or other portable communication device, enabling the communication device to provide the same functionality as device 20.

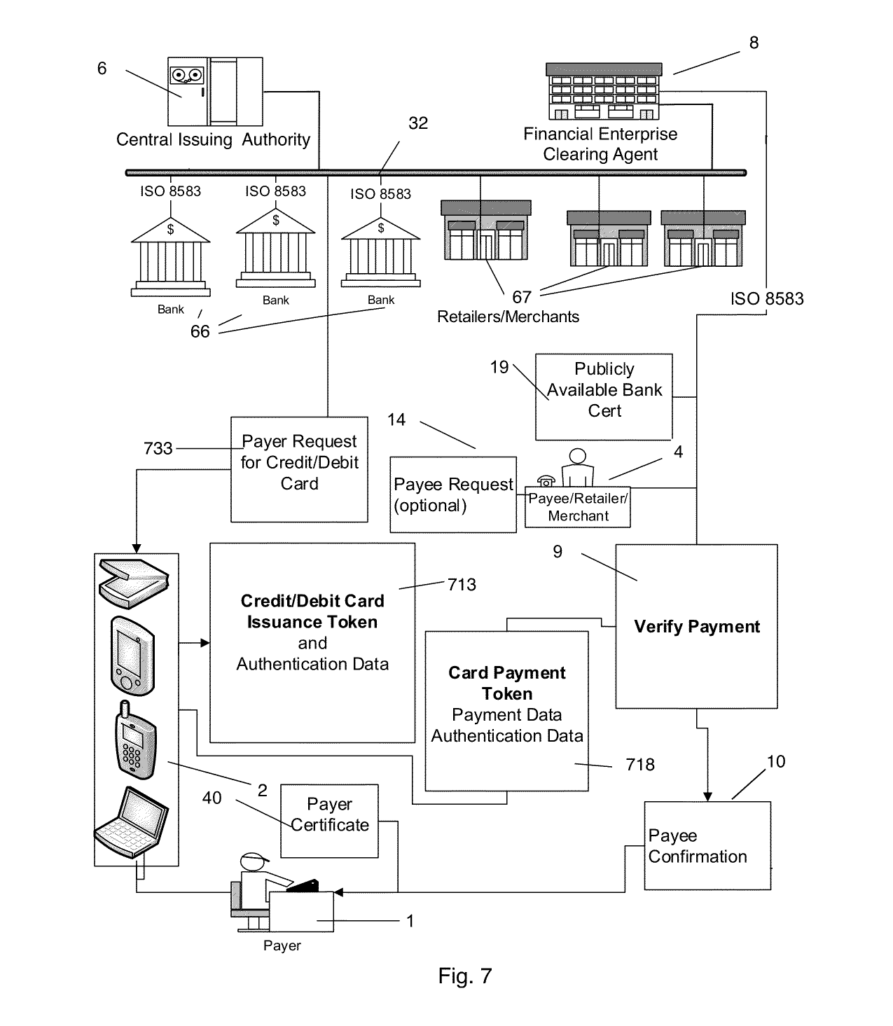

FIG. 7 shows an exemplary embodiment of the invention, illustrating electronic credit/debit card issuance according to The System. According to this embodiment, a Payer-participant 1 submits a request 733 for an electronic credit or debit card from the CIA 6, either directly or through a Financial Organization/Clearing Agent 8 or a Bank 66. The Payer 1 may submit the request using any of several devices 2; requests can also be submitted in writing on paper forms, or online via an Internet application. The request 733 includes at least a unique device ID, a Payer's debit/credit card Account Number, and the corresponding Bank or Card Issuer. When a valid certificate does not exist in the device 2, a Certificate request, or CSR, will be included in the request 733, based on a specific private key of the user and/or the device.

When the CIA gets a confirmation from the Payer's bank or card issuer authorizing or approving the request, the CIA issues an electronic Credit/Debit Card Issuance Token 713, which consists of electronic information that, according to the invention, comprises at least the following:
1. CIA Server Name: Identifies a card issuance server or root bank;
2. Issuance Date: The date of issuance of Credit/Debit Card Issuance Token 713;
3. Expiry Date: Limits the time period of the validity Credit/Debit Card Issuance Token 713.
4. Token Serial Number: Uniquely identifies each Credit/Debit Card Issuance Token 713.
5. Device ID: The Payer device ID to which the Credit/Debit Card Issuance token was issued; and
6. Cert/key#: The Root Authorization Certificate serial number used to sign the Credit/Debit Card Issuance Token 713.

In addition to the Credit/Debit Card Issuance Tokens, the CIA issues a device/user Certificate when the device 2 does not have such a certificate. The certificate is issued to the Payer and is associated with the ID of the device which is used to store the Credit/Debit Card Issuance Token 713.

The Credit/Debit Card Issuance Token 713 is signed with one of the CIA private keys which specific serial number is a data element of the electronic information of the Credit/Debit Card Issuance Token. The corresponding CIA public keys are published as CIA certificates which are distributed to all participants of the system and are available to any participant. The CIA publishes all the certificates used for Credit/Debit Card Issuance, and it distributes to the participants any new root certificates that it generates.

The CIA server keeps track of the serial numbers of the Credit/Debit Card Issuance Tokens 713 within the system. The Credit/Debit Card Issuance Tokens 713 are digitally signed by the bank using a specific Root Authorization Certificate number.

The Credit/Debit Card Issuance Token 713 is received and stored in the payers' devices 2 as a single data unit. This data unit can be provided in any suitable form, e.g., in magnetic form, such as on a hard drive or diskette, in optical form, e.g., on a CD-ROM, or in electronic form in a solid state memory device. The token data unit can also be transferred to the user via electronic mail, TCP/IP, or other communication method. Thus, there is no limitation whatsoever to the channel through which the electronic Credit/Debit Cards can be provided to the user.

According to a preferred embodiment of the invention, the payer's device 2 will be installed with software, as described above, which manages the transfer of the Credit/Debit Card Issuance Tokens 713 and Credit/Debit Card Payment Tokens 718 from the payer 1 to the Payee/Retailer/Merchant 4. The software may also display, on the participants' device 2, a graphical representation of the Credit/Debit Card Issuance Token and some of its data elements, e.g., an image of the plastic debit or credit card, or an image of a card charge slip. This optional feature serves to give new users a sense of familiarity, and a greater level of comfort, with transactions carried out using the System.

FIG. 7 also schematically illustrates a payment process, by which a Payer 1 pays a Payee/Retailer/Merchant 4 using an issued Credit/Debit Card Issuance Token 713. Payer 1 interacts with a Payee 4, using one of the Payer Devices 2, as described above in connection with FIG. 2. The Payer Device 2 generates and sends to the Payee 4 a Credit/Debit Card Payment Token 718 with the Payee's device ID and the Credit/Debit Card Issuance Token 713 and other payee's information signed into the Credit/Debit Card Payment Token 718. It should be noted that the Issuance Token 713 information is written into the Payment Token 718.

It is a notable feature of the present invention that the Payer 1, after being provided with a Credit/Debit Card Issuance Token 713, can generate and transfer one or more valid and redeemable Credit/Debit Payment Tokens 718 to one or more Payees without involvement of the CIA 6, Banks 66, or Clearing Agent 8.

Communication between the payee′ and payers' devices is preferably done using the incorporated Software. The Software preferably manages the transmission of the Credit/Debit Card Payment Token 718 and the certificate exchanges, and signs into the Credit/Debit Card Payment Token 718 the Payee's identity, device ID and other Payee information. The Software installed in the Payee's devices receives the data packets that constitute the Credit/Debit Card Payment Token 718, and examines the data packets and verifies (9) their authenticity. The software uses the published CIA certificate 19 and the Payer's Certificate 40 to verify the authenticity and validity of the data of Credit/Debit Card Payment Token 718. The Payee optionally can further verify the Credit/Debit Card Payment Token 718 via ISO 8583 messaging as described above. The CIA 6 can provide authenticity information to the payee based on the serial number and the payer's device ID, which are stored as data elements in the Credit/Debit Card Issuance Token 13 and the Credit/Debit Card Payment token 718. However, the published CIA root certificate 19 and the Payer's Certificate 40 are sufficient to validate the payment. When the Payee deposits the Credit/Debit Card Payment Token into his bank account, or with a Financial Enterprise/Clearing Agent 8, the designated amount of the transaction is debited from the Payee's credit card or cash account and credited to the Payee's account. A payee confirmation 10 is generated and transmitted to the Payer, and the Credit/Debit Card Payment Token 718 is marked as used and removed from circulation.

Alternatively, the Software may be used to transfer the Credit/Debit Card Payment Tokens directly to the Financial Enterprise/Clearing Agent 8 or to the Payee's bank 66 for later deposit, at a time elected by or agreed to by the Payee and/or Payer. Variations on the described procedures for transferring and exchanging Credit/Debit Card Payment Tokens can readily be devised by a skilled person.

According to a preferred embodiment of the invention, in order to facilitate record keeping, the Software writes and stores suitable information on the transactions in a protected data area of the Payer's device 2, and similar information may be written to a device of the Payee.

In the course of issuing Credit/Debit Card Issuance Token 713, and/or Credit/Debit Card Payment Token 718, or in the course of facilitating any transaction between the Payer 1 and the Payee 4, the invention provides for a commission for the service, which may be charged to the Payer 1, the Payee 4, and/or the Retailers/Merchants 67. The imposition of a commission will be regulated by predetermined rules between and among the CIA 6, the participating Banks 66 and Retailers/Merchants 67, and the Payers 1, Payees 9, and other participants in the System.

With each payment transaction, the Payee's Software sends a Payee Confirmation 10 to the Payer. The Payee Confirmation 10 comprises at least the following data elements:
1. Payment Amount,
2. Payment Token ID or serial number,
3. Payment Date, and
4. Payee ID or Payee Device ID.

A confirmation number and a Payee's Certificate/Key, to be used for Payment Confirmation, may be included with Confirmation 10. When the Payee confirmation 10 is received by the Payer's Device 2, the Software on the device removes the Credit/Debit Card Payment Token 718 from its storage area and/or marks it as used. The Software can then record additional information concerning the transaction, such as the identity and Device ID of the Payee to which the Payment Token has been transferred, the date and time of the transaction, etc., as explained above, for the purpose of record keeping.

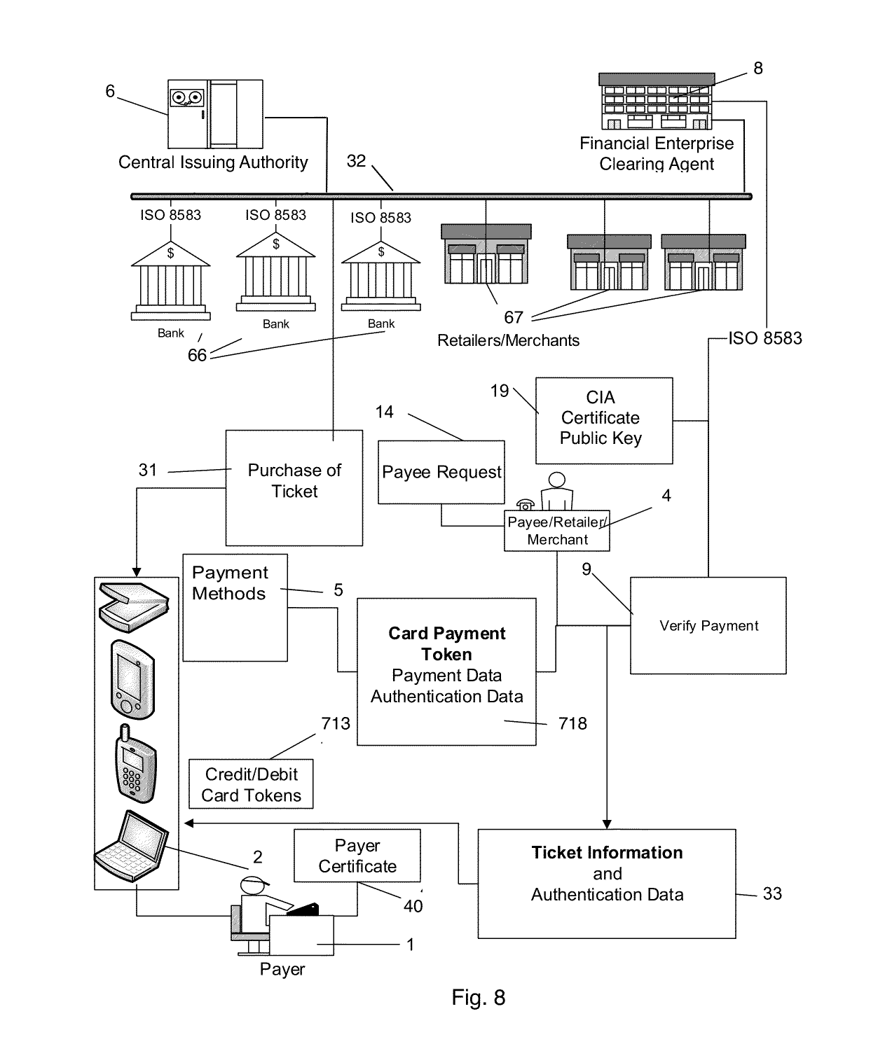

FIG. 8 schematically illustrates a payment process using the same issued electronic debit/credit card, according to a preferred embodiment of the invention, by which a Payer 1 pays the Payee 4 using Debit/Credit Card Payment Token 718. Payer 1 interacts with a Payee 4, using Payer's Device 2, as described above. In this embodiment the Payee 1 purchases (31) a Ticket from the Payee 4. When a credit/debit card transaction has been decided upon, payment is effected as described above via the Software of the invention. In this embodiment, payment confirmation is in the form of an electronic ticket 33 purchased by the payee. The electronic ticket 33 comprises at least the following data elements:
1. Payment amount,
2. Payment and issuance dates,
3. Payers Device ID or Payer's ID,
4. Payment Token ID or serial number,
5. Ticket Data (ID number, event/flight, date, time, etc.), and
6. Digital signature of ticket issuer

As above, a confirmation number and a Payee's Certificate/Key, to be used for Payment Confirmation, may be included. The ticket data is then stored in the payer's device 2 and can be presented graphically or delivered electronically in order to redeem the ticket, or to any person or entity requesting to validate or view the ticket.

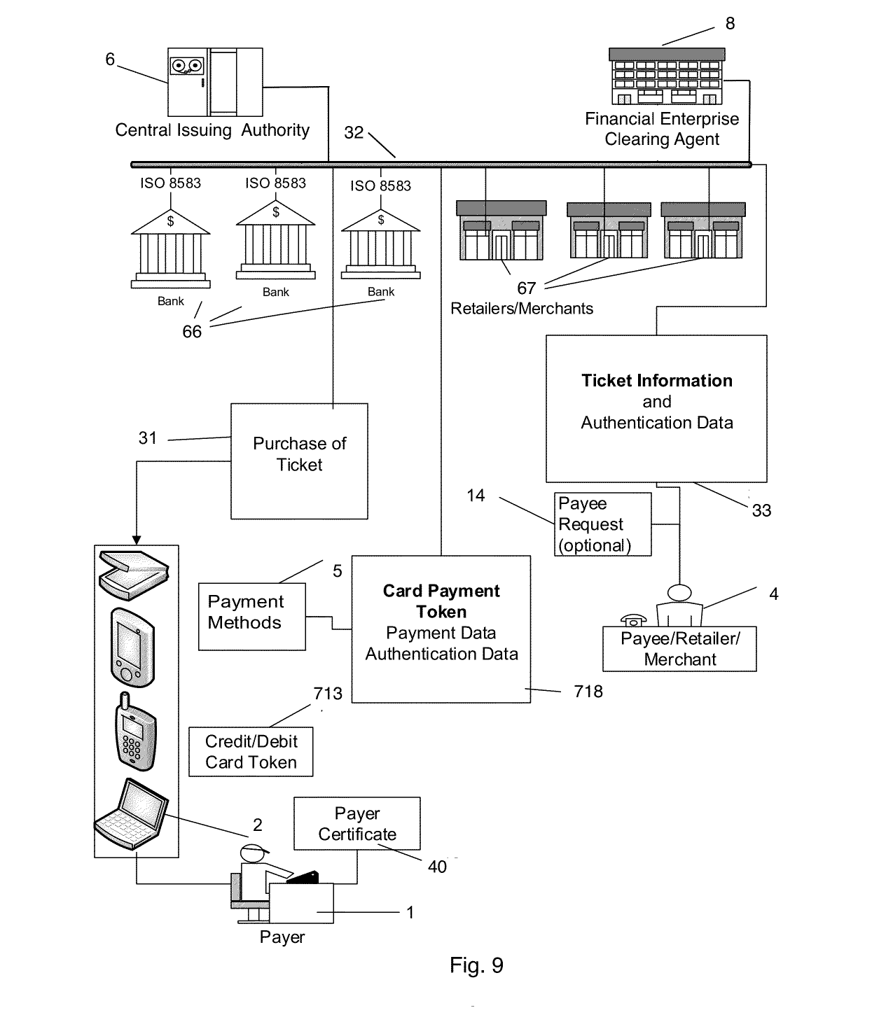

FIG. 9 illustrates a payment process for purchase of a ticket, analogous to that shown in FIG. 8, but wherein the ticket is not delivered to Payer's device 2. In this embodiment, the ticket is not delivered by the System or Software of the invention, but is delivered by prior art means, such as mail or courier delivery of a paper copy, or by electronic transmission of a printable email attachment or downloadable file.

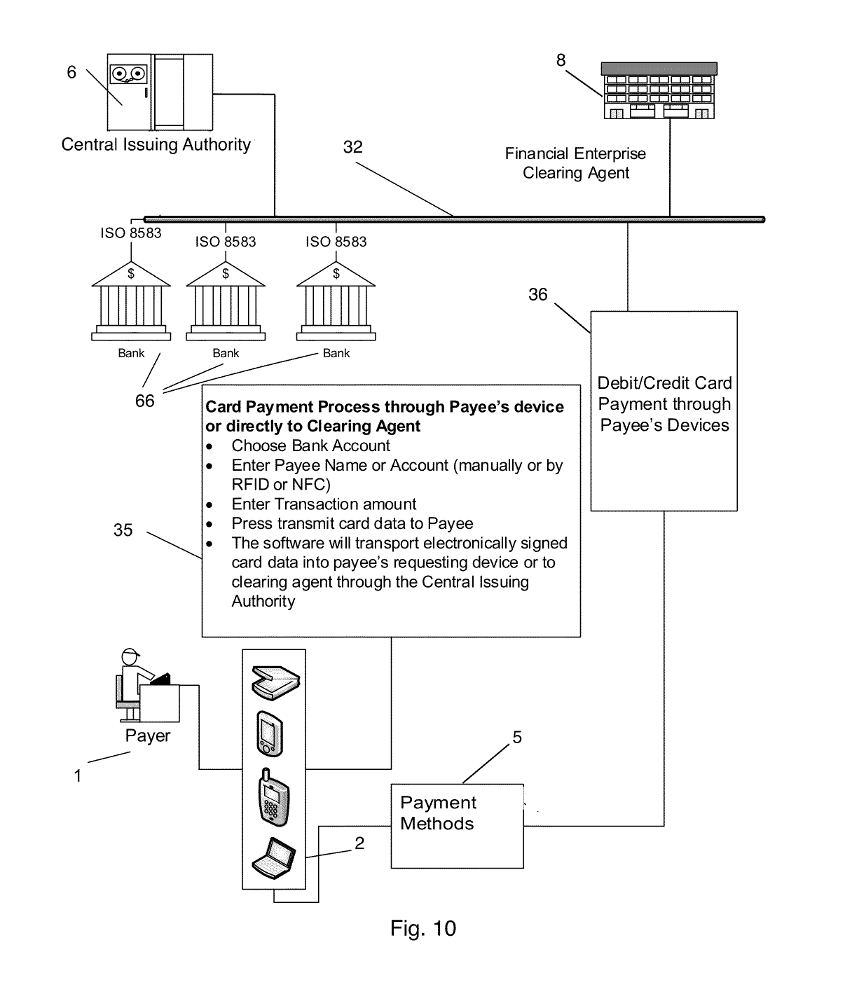

FIG. 10 schematically illustrates a payment process using issued electronic Debit/Credit Card Issuance Tokens, according to an alternative embodiment of the invention. The Payer 1 effectuates a payment by doing the following:
1. Selecting payment by credit or debit card from the available Payment Methods 5;
2. Choosing a debit or credit card Account from a drop down menu of the Payer's card accounts;
3. Entering a Payee identification (name, ID number, or selection from a list);
4. Entering a Transaction amount; and
5. Issuing a command to transmit check data to the Payee.

Optionally, the Payer may enter transaction identifying information, such as the Payee's invoice number. In alternative embodiments, Payee and transaction identification information may be automatically entered by the Software in response to a Payee Request. The software will transport an electronically signed Debit/Credit Card Payment Token 718 to the requesting payee's device. The Payee software then verifies the Debit/Credit Card Payment Token data with the publicly available CIA certificate and the device ID of the payee [role of payee device ID is not clear]. Optionally an ISO 8583 message could be sent to the issuing bank to further verify the payment token and then deposit the payment into the Payee's bank account. Upon deposit of the payment token in the payee's account, the amount of the transaction is debited from the Payer's credit card or cash account, and credited to the Payee's account.

Other embodiments of the invention include implementation of electronic Card Payment tokens that have cash value but are not necessarily credit or debit cards. Exemplary embodiments includes gift cards, cash value cards, membership and discount cards, and electronic tickets, any of which can utilize the principles of the invention without exceeding the scope of the claims.

While embodiments of the invention have been described by way of illustration, it will be understood that the invention can be carried out by persons skilled in the art with many modifications, variations and adaptations, without departing from its spirit or exceeding the scope of the claims. For instance, other networks can be used instead of the Internet, many different data manipulation methods and procedures can be devised, and many different programs, security means and accessories can be used, all without departing from the scope of the invention.

I claim:

1. A system for making monetary payments between participant payers and payees, comprising:
(a) at least one Central Issuing Authority (CIA);
(b) at least one electronic server for generating and issuing electronic checks, debit cards and credit cards, in the form of Issuance Tokens, to participant payers; and
(c) a plurality of transaction devices for use by participant payers, each device having a unique ID and each device being adapted for
(i) the storage of said Issuance Tokens,
(ii) the generation of Payment Tokens,
(iii) communicating with participant payees, and
(iv) performing check and credit/debit card transactions with participant payees;
wherein:
(a) said electronic server generates Issuance Tokens in coordination with correspondent banks that associate each Issuance Token with an account of an individual participant payer;
(b) each Issuance Token is signed with a CIA private key, identified by a specific serial number which is a data element of the Issuance Token; and
(c) each Payment Token comprises a public key identifying at least
(i) the monetary value represented by the Payment Token,
(ii) the Issuance Token from which the Payment Token is derived,
(iii) the individual participant payer whose account is associated with said Issuance Token, and
(iv) the unique ID of said individual participant payee's transaction device.

2. A portable device for the generation, storage, and transmission of Payment Tokens, comprising:
(a) a display,
(b) a means for operator input of commands and information,
(c) computer memory,
(d) a secure digital data storage area in said computer memory,
(e) a communications port,
(f) an application program in said computer memory, and
(g) a processor configured to execute said application program;
wherein execution of said application program enables an operator of the device to:
(a) enter into the computer memory data identifying a checking or credit card account,
(b) create a request for a Check Issuance Token or a Card Issuance Token,
(c) transmit said request to a Central Issuing Authority, and
(d) receive a Check Issuance Token or a Card Issuance Token.

3. The device of claim 2, wherein the means for operator input is a touch screen.

4. The device of claim 2, wherein the means for operator input is a physical keyboard.

5. The device of claim 2, wherein execution of the application program further enables the operator of the device to receive a digital certificate.

6. The device of claim 5, wherein execution of the application program further enables the operator of the device to:
(a) enter into the computer memory data identifying a payee,
(b) enter into the computer memory data specifying an amount to be paid to the payee,
(c) create a Check Payment Token derived from the Check Issuance Token,
(d) sign the Check Payment Token with the digital certificate, and
(e) transmit the Check Payment Token to the payee or to an account of the payee.

7. The device of claim 6, wherein the application program causes an image of a check to be displayed on the display, wherein the image is of a check made out to the payee for the amount to be paid to the payee.

8. The device of claim 5, wherein execution of the application program further enables the operator of the device to:
(a) enter into the computer memory data identifying a payee,
(b) enter into the computer memory data specifying an amount to be paid to the payee,
(c) create a Card Payment Token derived from the Card Issuance Token,
(d) sign the Card Payment Token with the digital certificate, and
(e) transmit the Card Payment Token to the payee or to an account of the payee.

9. The device of claim 8, wherein the application program causes an image of a credit card charge slip to be displayed on the display, wherein the image is of a credit card charge slip identifying the payee and showing a charge for the amount to be paid to the payee.

10. The device of claim 6, wherein execution of the application program enables the operator of the device to receive and authenticate a Payee Confirmation.

11. The device of claim 8, wherein execution of the application program enables the operator of the device to receive and authenticate a Payee Confirmation.

12. The device of claim 2, wherein the device is a smart phone.

13. The device of claim 2, wherein the device is a tablet computer.

14. A portable device for the generation, storage, and transmission of Payment Tokens, comprising:
(a) a display,
(b) a means for operator input of commands and information,
(c) computer memory,
(d) a secure digital data storage area in said computer memory,
(e) a communications port,
(f) an application program in said computer memory, and
(g) a processor configured to execute said application program;
wherein said application program is configured to:
(a) receive data input by an operator, the data identifying a checking or credit card account, and
(b) in response to instructions from the operator,
i. create a request for a Check Issuance Token or a Card Issuance Token,
ii. transmit said request to a Central Issuing Authority, and
iii. receive a Check Issuance Token or a Card Issuance Token.

15. The device of claim 14, wherein the application program is further configured to:
(a) receive into the computer memory data identifying a payee,
(b) receive into the computer memory data specifying an amount to be paid to the payee, and
(c) in response to instructions from the operator,
i. create a Check Payment Token derived from the Check Issuance Token,
ii. sign the Check Payment Token with the digital certificate, and
iii. transmit the Check Payment Token to the payee or to an account of the payee.

16. The device of claim 14, wherein the application program is further configured to:
(d) receive into the computer memory data identifying a payee,
(e) receive into the computer memory data specifying an amount to be paid to the payee, and
(f) in response to instructions from the operator,
iv. create a Card Payment Token derived from the Card Issuance Token,
v. sign the Card Payment Token with the digital certificate, and
vi. transmit the Card Payment Token to the payee or to an account of the payee.
